(19) United States
(12) Patent Application Publication
(10) Pub. No.: US 2013/0198182 A1
(43) Pub. Date: Aug. 1, 2013

(54) METHOD, SYSTEM AND PROGRAM FOR COMPARING CLAIMED ANTIBODIES WITH A TARGET ANTIBODY

(71) Applicants: Amar Mohan DRAWID, Bridgewater, NJ (US); Tai-He XIA, Bridgewater, NJ (US)

(72) Inventors: Amar Mohan DRAWID, Bridgewater, NJ (US); Tai-He XIA, Bridgewater, NJ (US)

(73) Assignee: SANOFI, Paris (FR)

(21) Appl. No.: 13/562,784

(22) Filed: Jul. 31, 2012

Related U.S. Application Data
(60) Provisional application No. 61/522,975, filed on Aug. 12, 2011.

(30) Foreign Application Priority Data
Jun. 15, 2012 (FR) 1255623

(51) Int. Cl. G06F 17/30

(52) U.S. Cl. CPC G06F 17/30286
USPC 707/736; 707/758; 715/230

(57) ABSTRACT

A method, system and program for facilitating consideration of clearance of a target sequence. The method comprises retrieving a predefined patent document library data structure having fields for claim identifiers, a matching criterion for a comparison, translated claim statements, matching procedures, sequence identifiers, logical relationships between claim statements and machine readable comparison instructions; retrieving a sequence database indexed by sequence identifier, comparing the target sequence with each of the claims in the retrieved patent document library data structure, using a corresponding machine readable comparison instructions and a sequence which is obtained from the retrieved sequence database corresponding to a sequence identified in the claim and determining whether each of claims in the retrieved patent document library data structure matches the target sequence based upon a result of the comparison. Each predefined patent document library data structure can be user customized for each claim.

### CROSS-REFERENCE TO RELATED APPLICATIONS

This application is related to co-pending application entitled METHOD, SYSTEM, AND PROGRAM FOR COMPARING CLAIMED ANTIBODIES WITH A TARGET ANTIBODY, Ser. No. 61/522,975, which was filed on Aug. 12, 2011, the entirety of which is incorporated by reference.

### FIELD OF THE INVENTION

This disclosure relates to a method, a system and a program for comparing at least one claimed antibody with a target antibody. More particularly, this disclosure relates to a method, a system and a program for facilitating and assisting consideration of freedom to operate of a target antibody by comparing sequences in the claimed antibody with sequences in a target antibody using a database of annotated patent document claims.

### BACKGROUND

Determining a freedom to operate (“FTO”) for antibodies is especially difficult. This is because it requires multiple comparisons of an in-house target sequence against one or more sequences claimed in patent documents and patent document applications, where the claims can cover a plurality of sequence variations. The sequence variations provide companies the opportunity to claim an enormous number of sequences. Since a sequence can be of different lengths with each position of the sequence capable of having a plurality of values, companies can file patent document applications and obtain patent documents for trillions of antibody sequences. Additionally, patent document claims are often complex and written in convoluted language. Moreover, there is no standard format for expressing sequences or sequence patterns in the claims.

### SUMMARY OF THE INVENTION

Accordingly, disclosed is a system, database, method and a program that provides a systematic manner to determine a FTO of an antibody.

Accordingly, disclosed is a method for creating a computer readable data structure which is stored on a computer readable storage device. The computer readable data structure is configured as a library of patent documents to be queried for clearance. The method comprises instantiating a computer readable data structure having a plurality of data fields, for each patent document claim having a claim statement with at least one claimed sequence, associating a patent document claim with a claim identifier, receiving a matching criterion for a comparison of a target sequence with the patent document claim, translating the claim statement based upon the matching criterion, receiving a selected a matching procedure based upon the matching criterion and the at least one claimed sequence, receiving a description of the at least one claimed sequence using a sequence identifier for each of the at least one claimed sequence, generating, using a processor, machine readable comparison instructions based upon the sequence identifier for each of the at least one claimed sequence, the matching criterion and the matching procedure and populating, using the processor, the plurality of data fields within the computer readable data structure with the claim identifier, the matching criterion, the matching procedure, the translated claim statement, described sequence identifier for each of the at least one claimed sequence, and the machine readable comparison instructions.

The method further comprises receiving a selected first tolerance level based upon the matching criterion. The first tolerance level is used to determine a match. The first tolerance level is populated into one of the plurality of data fields within the computer readable data structure.

The method further comprises receiving a selected second tolerance level based upon the matching criterion. The second tolerance level is used to determine a partial match. The second tolerance level is populated into another of the plurality of data fields within the computer readable data structure.

The method further comprises receiving a determination if patent document claim has a claim statement that is a complex statement. If the claim statement is a complex statement, the method further comprises dividing the claimed statement into a plurality of sub-statements, where each of the plurality of sub-statements includes at least one claimed sequence, receiving a determination of a logic relationship between each of the claim sub-statements, receiving a matching criterion for a comparison for each of the plurality of sub-statements, translating each of the sub-statements based upon the matching criterion; receiving a selected matching procedure based upon the matching criterion and the at least one claimed sequence in each of the plurality of sub-statements, receiving a description of the at least one sequence using a sequence identifier for each of the plurality of sub-statements with a sequence identifier for each of the at least one sequence, generating aggregate machine readable comparison instructions code for processing for all of the plurality of sub-statement, the aggregate machine readable comparison instructions including, the sequence identifier for each of the at least one sequence, the matching criterion and the matching procedure for each of the plurality of sub-statements and determined logic relationship and populating the plurality of data fields within the computer readable data structure with the claim identifier, the matching criterion for each of plurality of sub-statements, translated sub-statement, the matching procedure for each of the plurality of sub-statements, the described sequence identifier for each of the plurality of sub-statements, determined logic relationship and aggregate machine readable comparison instructions.

The method further comprises receiving at least one special comparison instruction for the selected matching procedure. If the claim statement is a simple statement, the special comparison instruction is selected from a group consisting of counting a gap at a first and a second end of a sequence alignment as a mismatch, counting a gap at a first and a second end of a sequence alignment as a mismatch only when the target sequence is longer than the at least one claimed sequence, and calculating a percentage homology when using a global alignment.

If the claim statement is complex, the special comparison instruction is selected from a group consisting of counting a gap at a first and a second end of a sequence alignment as a mismatch, counting a gap at a first and a second end of a sequence alignment as a mismatch only when the target sequence is longer than the at least one claimed sequence, calculate a percentage homology when using a global alignment, count an aggregate number of mismatches in sequence alignment for each of the plurality of sub-statements and calculate a combined identity over a plurality of sub-statements based on total length and number of mismatches, and a threshold number of matches for each of the plurality of sub-statements.

The method further comprises populating a field of the plurality of fields with the special comparison instruction and adding the special comparison instruction to the machine readable comparison instructions.

The method further comprises receiving a first regular expression representing a matching pattern including all allowed variations at each position, for each position within the at least one claimed sequence, and receiving a group of special regular expressions. Each special regular expression represents a specific matching pattern including all allowed variations for a different position within the at least one claimed sequence. The group of special regular expressions is only used if the target sequence satisfies the first regular expression based upon the matching pattern. A number of special regular expressions in the group of special regular expressions that is not satisfied equals a number of mismatches between the target sequence and the at least one claimed sequence.

Also disclosed is a method of facilitating consideration of clearance of a target sequence comprising retrieving a predefined patent document library data structure having fields for claim identifiers, a matching criterion for a comparison, translated claim statements, matching procedures, sequence identifiers, logical relationships between claim statements and machine readable comparison instructions, retrieving a sequence database indexed by sequence identifier, comparing the target sequence with each of the claims in the retrieved patent document library data structure, using corresponding machine readable comparison instructions and a sequence which is obtained from the retrieved sequence database corresponding to a sequence identified in the claim and determining whether each of claims in the retrieved patent document library data structure matches the target sequence based upon a result of the comparison.

If the matching criterion includes a corresponding first tolerance level, the determining comprises obtaining a raw comparison result from the comparing and comparing the raw comparison result with the first tolerance level. The target sequence matches a claim if the raw comparison result satisfies the first tolerance level. The comparing counts a gap at a first and second end of a sequence alignment as a mismatch only when the target sequence is shorter than the at least one claimed sequence, in a default mode.

If the matching criterion includes a corresponding second tolerance level, the determining comprises obtaining a difference between the raw comparison result and the first tolerance level; and comparing the obtained difference with the second tolerance level. The target sequence partially matches a claim if the obtained difference is less than the second tolerance level.

The determination is displayed. A match is displayed in a first color, a partial match is displayed is a second color and a non-match is displayed a third color. The claim identifier for a claim, a translated claim statement, the raw comparison result and the determination, the claim identifier and the translated claim statement being retrieved from the predefined patent document library data structure are also displayed. Further at least a portion of a claimed sequence and the target sequence is displayed and is associated with the display of the claim identifier, the translated claim statement, the raw comparison result and the determination.

Also disclosed is a method for creating a computer readable data structure which is stored on a computer readable storage device. The computer readable data structure is configured as a library of patent documents to be queried for clearance. The method comprises instantiating a computer readable data structure having a plurality of data fields, providing a user interface for inputting annotations to a patent document claim having a claim statement with at least one claimed sequence, receiving the input annotations, the input annotations being a matching criterion for a comparison of a target sequence with the patent document claim, a matching procedure, and a sequence identifier for each of the at least one claimed sequence, generating, using a processor, machine readable comparison instructions based upon the sequence identifier for each of the at least one claimed sequence, the matching criterion and the matching procedure and populating, using the processor, the plurality of data fields within the computer readable data structure with the claim identifier, the matching criterion, the matching procedure, described sequence identifier for each of the at least one claimed sequence, and the machine readable comparison instructions.

Also disclosed is a computer readable storage device tangibly embodying a computer readable program for causing a computer to execute a method comprising instantiating a computer readable data structure having a plurality of data fields, providing a user interface for inputting annotations to a patent document claim having a claim statement with at least one claimed sequence, receiving the input annotations, the input annotations being a matching criterion for a comparison of a target sequence with the patent document claim, a matching procedure, and a sequence identifier for each of the at least one claimed sequence, generating, using the computer, machine readable comparison instructions based upon the sequence identifier for each of the at least one claimed sequence, the matching criterion and the matching procedure and populating, using the computer, the plurality of data fields within the computer readable data structure with the claim identifier, the matching criterion, the matching procedure, described sequence identifier for each of the at least one claimed sequence, and the machine readable comparison instructions.

Also disclosed is a computer readable storage device tangibly embodying a computer readable program for causing a computer to execute a method comprising retrieving a predefined patent document library data structure having fields for claim identifiers, a matching criterion for a comparison, translated claim statements, matching procedures, sequence identifiers, logical relationships between claim statements and machine readable comparison instructions, retrieving a sequence database indexed by sequence identifier, comparing the target sequence with each of the claims in the retrieved patent document library data structure, using corresponding machine readable comparison instructions and a sequence which is obtained from the retrieved sequence database corresponding to a sequence identified in the claim and determining whether each of claims in the retrieved patent document library data structure matches the target sequence based upon a result of the comparison.

### BRIEF DESCRIPTION OF THE FIGURES

These and other features, benefits, and advantages of the present invention will become apparent by reference to the following figures, with like reference numbers referring to like structures across the views, wherein:

FIG. 1 illustrates a block diagram of an exemplary clearance system in accordance with the invention;

FIG. 2 is a table depicting exemplary classes of annotations and examples of annotations within each class;

FIGS. 3A-3B illustrate a table of categories for a claim;

FIGS. 4-5 illustrate a flow chart for the steps of generating a patent document library in accordance with the invention;

FIG. 6 illustrates a flow chart for steps of comparing a target sequence with the claims from the patent document library; and

FIG. 7 illustrates a flow chart showing exemplary steps for analyzing the raw score.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “module” or “system.”

Various aspects of the present invention may be embodied as a program, software, or computer instructions embodied in a computer or machine usable or readable storage device, which causes the computer(s) or machine(s) to perform the steps of the method(s) disclosed herein when executed on the computer, processor, and/or machine. A program storage device readable by a machine, tangibly embodying a program of instructions executable by the machine to perform various functionalities and methods described in the present disclosure is also provided.

The system and method of the present invention may be implemented and run on a general-purpose computer or special-purpose computer system or multiple general-purpose computers or special-purpose computer system.

Each computer system may be any type of known or will be known systems and may typically include a processor(s), memory and storage devices, input/output devices, internal buses, and/or a communications interface for communicating with other computer systems in conjunction with communication hardware and software, etc. A storage device includes, but is not limited to, optical media, such as CD, DVD, magnetic media, and solid-state memory devices.

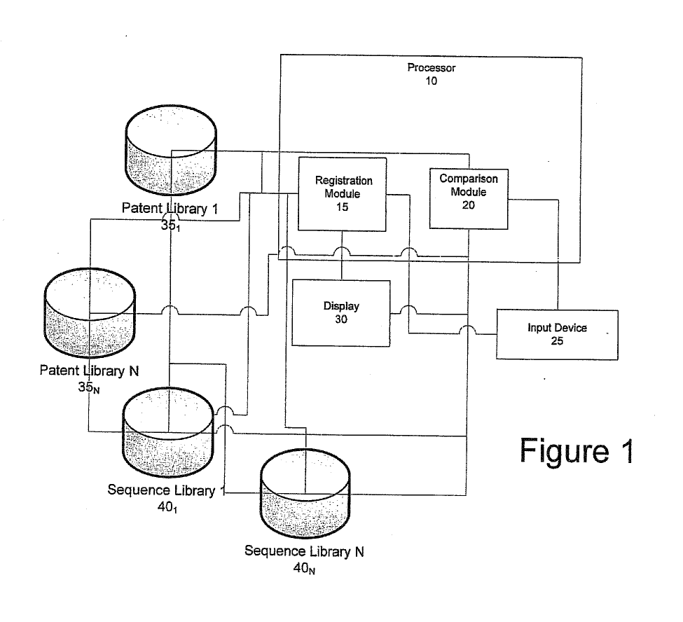

FIG. 1 illustrates an exemplary clearance system 1 in accordance with the present invention. The clearance system 1 is for facilitating and assisting consideration of freedom to operate of a target antibody by comparing sequences in the claimed antibody with sequences in a target antibody using a database of annotated patent document claims. The facilitating and assisting consideration of freedom to operate includes comparing sequence information and identification information with one or more patent document claims, listing of the percentage homology, identification of matching CDRs, ranking of relevance, displaying the comparison, and the like. For purposes of this disclosure patent document includes, but is not limited to, domestic and foreign patents, patent applications, patent publications, reissued patents, PCT applications, or any document granted by a government which contains a legal description of an invention.

The clearance system 1 includes a processor 10, an input device 25, a display 30, at least one patent document library (collectively “35”) and a sequence library (collectively “40”). The clearance system 1 is used to annotate a plurality of patent documents for a given subject, generate a database containing the annotations and compare any target sequence with the patent document claims in the patent document library 35. The patent document library 35 for each given subject, e.g., patent document library 35_{N}, is only created once and later reused for comparison with many different target sequences. For example, a patent document library 35 can be created for all patent documents of interest related to a first molecule (Patent document Library 1 35₁) and a second patent document library can be created for all patent documents of interest related to a second molecule (Patent document Library 2 35₂). Additionally, there can be a separate patent document Library 35_{N} for each patent jurisdiction. Furthermore, there can be a separate patent document Library 35_{N} for patents and patent applications. Similarly, the sequence library 40 can be separated into different searches, jurisdictions and patents and patent applications.

The input device 25 can be a mouse, keypad or a touch screen display, or the like capable of being used to input annotations of a patent document claim. The user inputs the annotations via a graphical user interface (GUI) on the display 30. Alternatively, a command line prompt or another non-graphical interface can be used as an interface for the exchange of information between a user and the clearance system 1.

The processor 10 includes a registration module 15 and a comparison module 20. The registration module 15 is used to configure the patent document library 35 by creating claim records with a plurality of fields and populating the same with the annotations and a computer generated script for comparison. Additionally, the registration module 15 configures the sequence library 40 by creating sequence records and populating the same with annotated sequences. The sequence library 40 contains all relevant sequences for each patent document library 35. Additionally, the sequence library 40 can contain all relevant regular expressions and constrained regular expressions for each patent document library 35 which is created in accordance with the invention. The regular expressions and constrained regular expressions will be described in detail later. The sequence library 40 is indexed with an identification for each sequence and if a regular expression is created, by regular expression. For example, the identification for each sequence can be the sequence identifier obtained from either the patent document claim or patent document specification. Sequence identifier comes directly from the patent document claims. The registration module 15 uploads the sequences from a third party sequence database.

The comparison module 20 is programmed with a plurality of functions and sub-routines. For each claim comparison, the comparison module 20 executes a sub-set of these functions or sub-routines in a specific order based upon a script generated by the registration module 15 when the claim record is created and populated. The plurality of functions and sub-routines are described herein as selectable matching criterion, matching procedures, grouping logic, tolerances, and special instruction for comparisons. Additionally, if a claim cannot be annotated and compared using the programmed functions and sub-routines, a user can generate and customize a new function and sub-routine. The new function and sub-routine are stored in a storage device for later use. The new function and sub-routines can be used for comparison with any claim.

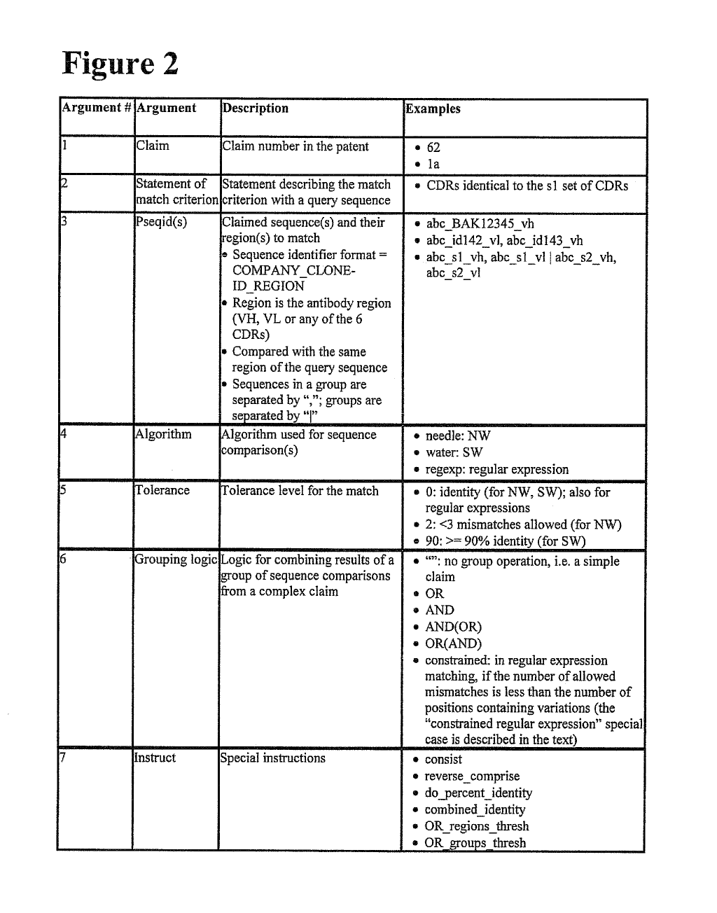

The registration module 15 provides a user with fields or arguments that can be input for later comparison use. For example, the registration module 15 can display a GUI having drop down fields and fill in boxes for a patent document number, a patent document claim number, a matching criterion (MCs), a claimed sequence identifier (and/or region(s)), a matching procedure (MPs), a first tolerance (T) for matching, a second tolerance (T2) for a partial match (optional), complex claim grouping logic, and any special comparison instruction for each claim. Complex claim grouping logic will be described in detail later. This information forms a claim record for a patent document claim and is stored in the patent document library 35. Additionally, T2 can be set as a global parameter for all comparisons of a particular type, e.g., a default parameter. FIG. 2 illustrates a table 200 containing several examples of fields or arguments that can be input into the claim record and stored in the patent document library 35 for each claim. As illustrated in FIG. 2, sequence regions “vl” and “vh” correspond to variable light chain and variable heavy chain regions, respectively; CDR is complementarity determining region; NW is a Needleman-Wunsch global alignment algorithm; SW is a Smith-Waterman local alignment algorithm. The table 200 includes seven classes of annotations, i.e., seven rows. Each class has examples of available input values.

The inventors have recognized that a patent document claim can be classified into three general categories and a plurality of sub-categories based upon an infringement or matching criterion. The clearance system 1 takes advantage of this recognition by allowing a user to classify a claim into the sub-categories and create a searchable patent document library, i.e. patent document library 35, having annotations and a computer generated script, for later comparison with a target sequence.

The general categories can include a claim directed to a particular sequence or any sequence that has less than a specific number of non-matching “positions” within the sequence, a claim directed to a particular sequence or any sequence that has more than a specific percent identify with the sequence, and a claim directed to certain variations of a particular sequence. Although the disclosure identifies three general categories as examples of the categories, any number of distinct categories can be used with the clearance system 1.

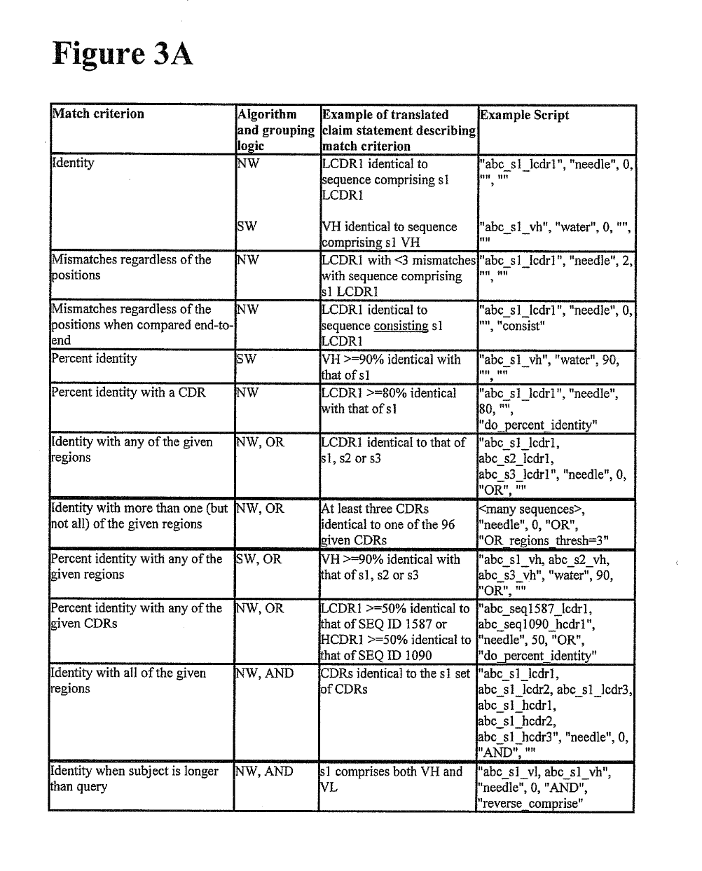

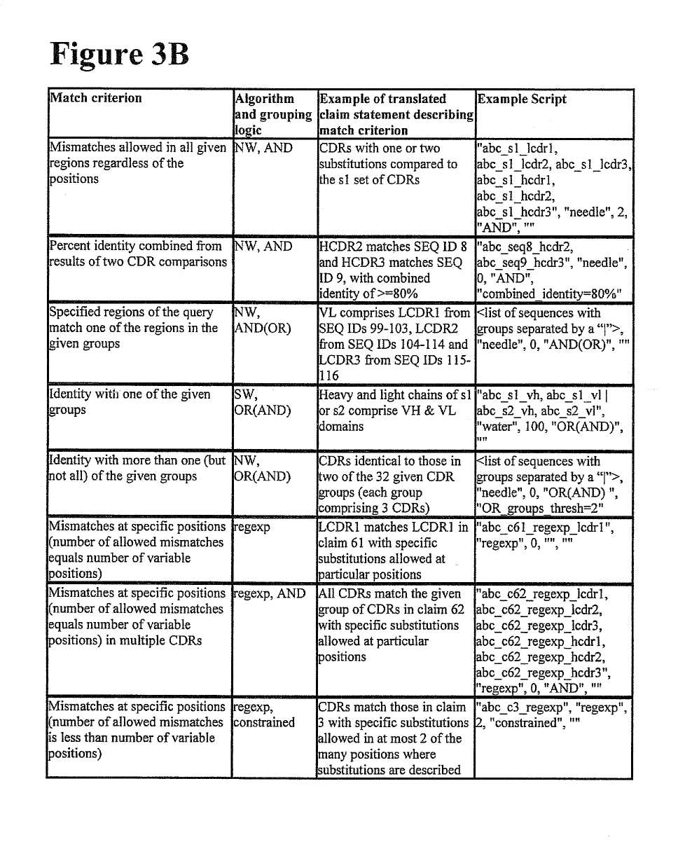

Using the categories as a selection framework, the user can select a matching criterion. FIGS. 3A and 3B illustrate a table 300 of categories for a claim. As illustrated in FIGS. 3A and 3B, sequence regions “vl”, “vh”, “lcdr1/2/3” and “hcdr1/2/3 correspond to variable light chain and variable heavy chain regions, variable light chains CDR1, 2, or 3, and variable heavy chains CDR1, 2, or 3, respectively; CDR is complementarity determining region; NW is a Needleman-Wunsch global alignment algorithm; SW is a Smith-Waterman local alignment algorithm; and regexp is a regular expression. Column 1 of the table 300 is a list of the matching criterion. The list is solely exemplary and not an exhaustive list. For example, the selected matching criterion can be the number of non-matching positions, a matching percentage for the sequence, or an allowable variation for the sequence. The user can also input a translation of the claim statement using matching criterion that the user wants displayed as part of a query record when a target sequence is compared, e.g., TransClaimStatement. A query record will be described in detail later. Alternatively, the registration module can create a translation of the claim statement. Table 300, column 3 illustrates examples of translations corresponding to the list of matching criterion. The examples correspond to arguments 3-7 from FIG. 2. In FIGS. 2 and 3A-3B, T2 is used as a global default parameter in the respective algorithms.

The user can select one matching procedure from a plurality of different matching procedures or algorithms to use for later comparison on a per claim basis (or sub-statement basis). For example, a global alignment algorithm can be used as the matching procedure. The global alignment algorithm can be, but is not limited to, a Needleman-Wunsch global alignment algorithm (“NW algorithm”). The NW algorithm as set forth in Needleman SB, Wunsch CD. (1970). A general method applicable to the search for similarities in the amino acid sequence of two proteins. J Mol Biol 48 (3): 443-53 which is incorporated by reference as if the alignment algorithm was fully set forth herein in detail. Additionally, a local alignment algorithm can be used as the matching procedure. The local alignment algorithm can be, but is not limited to, a Smith-Waterman local alignment algorithm (“SW algorithm”). The SW algorithm as set forth in Smith TF, Waterman MS (1981). Identification of Common Molecular Subsequences. J Mol Biol 147 (1): 195-197 which is incorporated by reference as if the alignment algorithm was fully set forth herein in detail. The selection of the matching procedure can be related to the matching criterion. For example, if the matching criterion is a number of mismatches, the NW algorithm can be used. If the matching criterion is percent identity, the SW algorithm can be used. If the matching criterion is identity, the selection can be based upon the length of the sequence. For example, if a sequence is short, such as a CDR sequence in an antibody, a global alignment algorithm can be used. If a sequence is long, such as the entire variable light or heavy chain in an antibody, a local alignment algorithm can be used.

Additionally, a pattern translation using a regular expression can be used as the matching procedure. The regular expression is used to express multiple possible strings in a concise format. If a pattern translation is used, each regular expression is generated prior to comparison. The regular expression can be automatically generated by the registration module 15 using the claim language and text and pattern recognition software. Alternatively, the user can input the regular expression via the input device 25. The registration module 15 will display an additional area for the user to input the regular expression via the GUI.

For example, if a claim covers a particular LCDR2 sequence “LASNLES” and its variations containing residues I, L, and V at position 2 and any residue at position 6, a regular expression could be used for the matching criterion and procedure. This type of claim is usually used for a CDR region. The comparison requires a significant amount of individual sequence components. However, the claim can be translated into a regular expression, which is used later for pattern recognition. The regular expression can be created using a number of computer languages, such as, but not limited to, Perl programming language, JAVA and Python. The computer language can be selected based upon familiarity of the language and recognition of patterns. For example, multiple residues at a particular position can be represented by using brackets and all possible residues at the position using “.”. The regular expression for the above-identified example could be “L[AILV]SNL.S”. The target sequence is compared with the regular expression pattern to determine if the target sequence matches any of the claimed variations.

The user can also input a first tolerance for the comparison. The tolerance for a NW algorithm is a user specified number of non-matches, e.g., T=3. The tolerance for a SW algorithm is user specified percentage, e.g., T=90%. The tolerance for the regular expression is zero. If a raw comparison score passes the tolerance level, then the target sequence is determined to match the claim. For example, if T=3 and the raw score or raw comparison indicates that there are two non-matches, then the target sequence matches the claim.

Additionally, a user might be interested in determining if a target sequence partially matches the claim, i.e., just misses the first tolerance level in the comparison and thus is close to the claim. A second set of user tolerances is used to determine partial matches, i.e., T2. For example, the second tolerance (T2) can be a small number of non-matches, such as 1 or 2. Alternatively, the second tolerance T2 can be a small percentage deviation from the first tolerance, such as 5%. Therefore, if the raw score or raw comparison result indicates that the target sequence has an 86% match with a claimed sequence, and T=90%, there is a partial match. The second tolerance for the regular expression is also zero as a target sequence either matches or does not match the regular expression.

Additionally, a claim can be translated into more than one preset matching criterions. A complex claim can be divided into sub-statements or blocks, where each block can be translated into a matching criterion (the same or different). For example, claims that deal with multiple sequence regions are annotated into multiple simple statements and combined using combinational logic. A simple claim only requires one sequence comparison, whereas a complex claim requires multiple comparisons. If the claims are divided into a sub-statement, the user determines the logical relationship. A complex claim is a claim that has either a single sequence that can be classified in multiple regions or a statement that can be divided into multiple blocks or regions, where each block or region is effectively a simple claim and the block is aggregated or combined to get a final result.

The user can select the logical relationship between the simple claim sub-statements or blocks, i.e., how they are combined. The selectable combining logic (ComLog) can be, but is not limited to “or”, “and”, “and(or)” and “or(and)”. For example, an “and(or)” combinational logic is used for a claimed sequence consisting of a light variable chain containing complementarity determining region 1(LCDR1) from SeqId 99-103, LCDR2 from SeqId 104-114 and LCDR3 from SeqID 115 or 116. An “or(and)” is used for a claimed sequence covering both variable chain regions where five pairs of variable light and heavy chain sequences are provided.

Additionally, the user can specify one or more special instructions for comparing a target sequence with the claim. The special instruction can be, but is not limited to, “consist”, “reverse_comprise”, “do_percent_identity”, “combined_identity”, “OR_regions_thresh”, and “OR_groups_thresh”. The “combined_identity”, “OR_regions_thresh”, and “OR_groups_thresh” are only used for complex claims. The “consist” is an instruction that causes the comparison module 20 to count gaps at both ends of the sequence alignment as mismatches. This special instruction is typically used for the NW algorithm. The registration module 15 can automatically generate this special instruction using text recognition software to parse the claim language, i.e., find the term “consisting of” near the queried sequence identifier. “Reverse comprise” is an instruction that causes the comparison module 20 to count gaps at both ends of the sequence alignment as a non-match only when the target sequence is longer than the claimed sequence (or block region). This special instruction is typically used for the NW algorithm. The “do_percent identity” is an instruction that causes the comparison module 20 to calculate a percentage of matching for the NW algorithm instead of counting the non-matches. The “combined_identity” is an instruction that causes the comparison module 20 to aggregate a number of non-matches in each of a plurality of simple comparison in a complex claim and calculate a combined percentage of matching for the NW algorithm. The “OR_regions_thresh” is an instruction that causes the comparison module 20 to perform a conditional modified “or” for a complex claim. The threshold is a number of simple or clauses (blocks or regions) that are needed to match before a final match is determined. For example, if a sequence in a complex claim is divided into 5 different regions, and an “OR_regions_thresh” is set to 3, three of the five regions must be individually deemed a match before the final combined aggregate result is deemed to be a match. The “OR_groups_thresh” is an instruction that causes the comparison module 20 to use a threshold for a number of complex clauses (which are each a combination of at least two simple clauses) needed to deem a final combined aggregate result a match. This instruction is only used for the “or(and)” combinational logic grouping.

The registration module 15 writes a comparison script (“script”) for each claim, for later use. The script is a header based script using the annotated information input by the user, e.g., information from arguments 3-7 from FIG. 2. Each function or sub-routine is identified by a header. The script provides a roadmap for the comparison module 20 to select a function and sub-routine in a specific order.

Additionally, the registration module 15 retrieves a claimed sequence from a third party database and stores the sequence in the sequence library 40. For example, using the input sequence identifier, patent document number and claim number, the registration module 15 queries the third party database for the sequence. Once the sequence is retrieved, the registration module 15 associates an identification of the sequence with the retrieved sequence in the sequence library 40. This identification of the sequence is used as an index for the retrieved sequence for the sequence library 40. Alternatively, the identification of the sequence is included in a header of the retrieved sequence.

The comparison module 20 compares a target sequence with the claim using the script for the claim record stored in the patent document library 35. This comparison generates a raw score or raw comparison result, e.g., number of non-matches or percentage. This raw score is compared with a tolerance (T).

The raw comparison result and decision thereon are output by the comparison module 20 to a display 30. Responsive to the reception of the raw comparison result (score) and the decision, the display 30 formats the data for display and appends this information to a query record. The query record includes a claim number for the claimed sequence, the TransClaimStatement, raw comparison result and the decision. Optionally, the query record can include a side-by-side display of the claimed sequence and the target sequence as evidence of the decision (or a relevant portion thereof). A match, partial match or no match is displayed with a different color indication. For example, the query record is displayed in red if there is a match, yellow if there is a partial match and a green if there is no match. Additionally, if multiple queries are run for different claims, the decisions can be grouped based upon a common result. For example, all query records having a match in the decision result can be displayed first, followed by all partial matches.

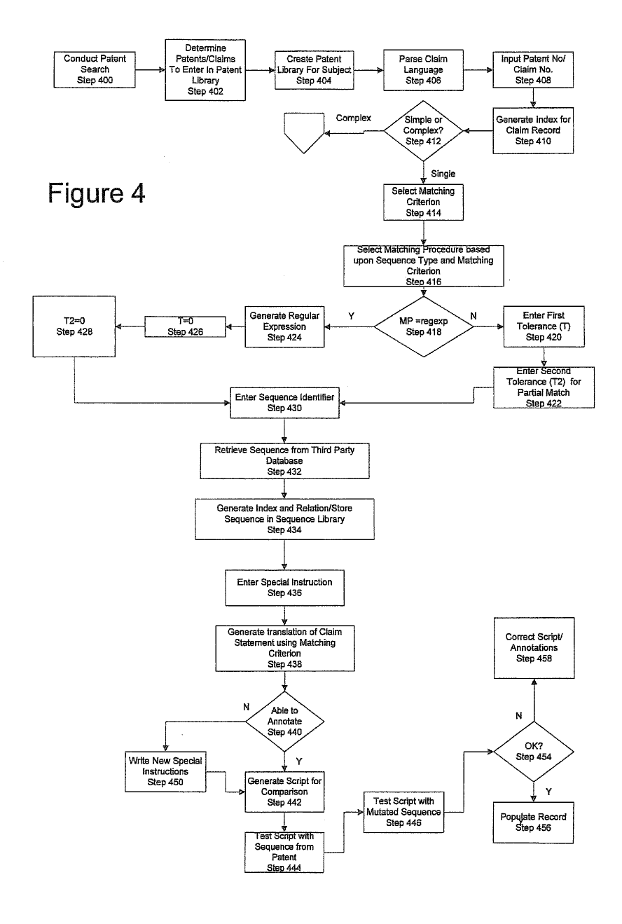

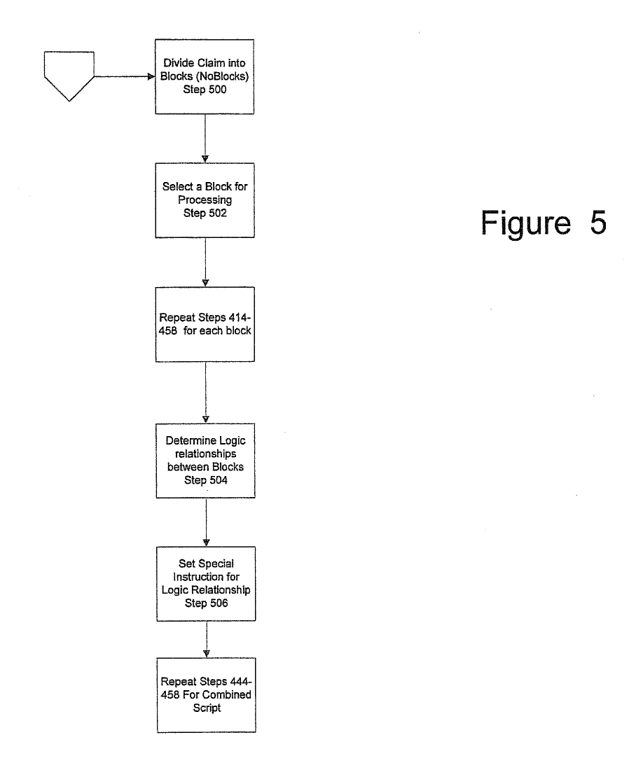

FIGS. 4-5 illustrate a flow chart for the steps of generating a patent document library 35 for a given subject. At step 400, a patent document search is conducted to obtain a plurality of relevant patent documents for a given subject. For example, the search can be for all patent documents related to antibodies or other sequence related to a specific entity, i.e., any antigen including a nucleic acid, a polypeptide, proteins, amino acids, a micro organism, and an organic compound.

At step 402, the user selects a sub-set of the patent documents and claims for inclusion into the patent document library 35. Only claims having sequences will be added to a patent document library 35. Non sequence claims are eliminated. Additionally, a sub-set of the claims are eliminated based upon at least one user selection criterion. For example, a claim dealing with only framework regions of an antibody may be eliminated. The at least one user selection criterion can also be percentage identity, length, region or domain.

Once the user determines which claims to include in a patent document library 35, the patent document library database, e.g., Patent document Library 1 35₁ is created by instantiating a plurality of fields, at step 404. The header for each field is defined, such as, but not limited to, patent document number, claim number, matching criterion, description of claim statement using matching criterion, matching procedure, logical relationship, first tolerance, second tolerance, regular expression (if necessary), special instructions, comparison script, etc. These headers correspond to user input information related to a claim and computer generated information including the claim identifier and script. A claim record includes all of the plurality of fields. The claim record is identified by a claim identifier, i.e., indexed. Additionally, a computer file is generated for the patent document library and associated with a file name. The file (i.e. database file) is stored in a storage device. The storage device can be a local device or located remotely on a computer network server.

Steps 406-458 and 500-506 are performed for each claim included in the patent document library, e.g., Patent document Library 1 35₁. At step 406, the user analyzes the claim to annotate the claim with the arguments set forth in the table 200 depicted in FIG. 2. This information can be input into a GUI with defined areas where the user can enter each of the arguments set forth in FIG. 2. Alternatively, the information can be input via a command prompt. Additionally, if the claim is about a CDR sequence and the CDR sequence is not explicitly provided in the subject patent, CDR is defined as a default, such that the amino acid sequence length is as large as possible for alignment purposes. It can be stored in the sequence library 40. The identification of a CDR is well known and is not described herein in detail.

At step 408, the patent document number and claim number for the claim is input using input device 25. At step 410, a claim identifier for the claim record is automatically generated. The claim identifier can be a direct combination of the patent document number and the claim number. Alternatively, the last three digits of the patent document number and the claim number can be used as the claim identifier. The claim identifier serves as a record index for the claim record. The above claim identifiers are only examples for the identifier. Any unique string can be used as the claim identifier.

At step 412, the user determines if the claim is a simple claim, requiring only one comparison, or a complex claim, requiring multiple comparisons. If the claim is a complex claim, the method proceeds to step 500. If the claim is a simple claim, the method proceeds to step 414. At step 414, the user inputs the matching criterion. The clearance system 1 can display a list of available matching criterions that the user can select. An example of the list of available matching criterion is illustrated in the first Column of table 300 in FIGS. 3A and 3B. The list can be displayed via the GUI, such as by using a drop down window. Alternatively, the user can directly input the matching criterion, e.g., typing the matching criterion.

At step 416, the user inputs the matching procedure. The clearance system 1 can display a list of available matching procedures that the user can select, e.g., NW, SW, and regexp. An example of the list of available matching procedures and grouping logic is illustrated in the second Column of table 300 in FIGS. 3A and 3B. The list can be displayed via the GUI, such as by using a drop down window. Alternatively, the user can directly input the matching criterion, e.g., typing the matching criterion.

At step 418, a determination is made if the matching procedure is a regular expression (pattern). If the matching procedure uses a regular expression, the regular expression is generated (step 424). The regular expression can be input by the user. Alternatively, the clearance system 1 can generate the regular expression using word and pattern recognition software. As described above, the regular expression can be stored in the sequence library 40. The regular expression can be also stored in the appropriate patent library 35. Word and pattern recognition is well known and will not be described herein in detail.

The user can set a matching tolerance that will be used for the comparison. At steps 420 and 426, the first tolerance is set. The first tolerance is used by the comparison module 20 to compare the target sequence with a claim. The first tolerance (T) for a regular expression is zero. T is set to zero for a regular expression at step 426.

The user can also choose to determine if the target sequence partially matches a claim. A second tolerance is used for this determination. At steps 422 and 428 (for regular expressions), the user sets the second tolerance. The second tolerance (T2) for a regular expression is also zero. T2 is set to zero at step 428.

At step 430, the sequence identifier(s) corresponding to the claimed sequence(s) are obtained. The user can enter the sequence identifier. Alternatively, the clearance system 1 can recognize a sequence identifier and automatically obtain it. Once the sequence identifiers are obtained (at step 430), the clearance system 1, via the registration module 15 retrieves the sequence from a third party database to add the sequence into a sequence library 40, at step 432 using known methods for obtaining the sequence. Such methods are not described in detail herein.

At step 434, the registration module 15 creates a sequence record for the retrieved sequence(s). The sequence record includes a header or index and the sequence(s). Additionally, the registration module 15 associates the sequence record with the claim record allowing for fast retrieval of the sequence during comparison of a target sequence with the patent document claim. The sequence record is added to the sequence library 40.

At step 436, any special comparison instructions are input via the GUI. Table 200 at row 7, Column 3 illustrates several examples of special instructions. Since the claim is a simple claim, “consist”, “reverse_comprise” and “do_percent_identity” would be examples of available options for special instructions.

At step 438, a translation of the claim statement is generated. This translation is displayed with a query record for each claim. The translation of the claim statement can be automatically generated by the registration module 15, using the input sequence identifier, and selected matching criterion. Alternatively, the user can input the translation of the claim statement via the GUI using the input device 25.

Most patent document claims are able to be annotated using steps 414-438, however, some claims may require special and customized functions and expressions for annotation due to the way that the sequences were claimed. For these types of claims, special annotations and processing instructions are generated, such as new expressions and relationships. At step 440, the user determines if the claim was able to be successfully annotated within the preset framework described in steps 414-438. If the annotation of the claim was successful, the method proceeds to step 442. If not, then the method proceeds to step 450.

At step 450, the special instructions are created. For example, a new regular expression is generated for the claim. If a claim specifies variations at multiple positions of a particular sequence, but covers only those sequences that have variations in fewer of the positions, the claim will require special treatment. The claim cannot be completely translated and annotated using steps 414-438. This type of claim requires the use of a “constrained regular expression”. In this case, multiple regular expressions are generated. For example, a regular expression is defined with a generic regular expression incorporating variations at all positions. Then a plurality of regular expressions are defined with special regular expressions corresponding to variations to each position that has a variation. For example, a claim covers sequence “LKS” and any sequence that has variation at two positions. The possible variations are “A” at position 1, “R and H” at position 2 and any residue at position 3. The generic regular expression for the pattern is “[LA][KRH]”. The special regular expressions are “L[KRH].”, “[LA]K.” and “[LA][KRH]S”. The generic and special regular expressions can be stored in the sequence library 40.

The relationship between each of the expressions is defined. Further, any additional comparison instructions are generated. For example, an instruction to solve the generic regular expression first can be input. For example, if the target sequence does not match the generic regular expression, the target sequence will not match the claim and therefore, the special regular expressions need not be solved. Additionally, an instruction to count a number of regular expressions that do not match can be input. Because each regular expression match checks if the target sequence and the claimed sequences have the same residues at a particular position, the number of regular expressions that do not match the target sequence equals the number of positions at which the target sequence and claimed sequence do not match. Another instruction can be for a partial match with the regular expressions. For example, if the counted number of regular expressions that do not match the target sequence is slightly more than the tolerance (T=2), then a partial match can be declared, e.g., T2=3. Therefore, if the count for the above example was 3 and the second tolerance is 3, there would be a partial match. The special instructions described above are only examples.

Once all of the expressions and special instructions are generated, the registration module 15 generates a comparison script for later use, at step 442. The script is based upon the selected matching criterions, the sequence identifier, the matching procedure, regular expressions, any special instructions and the first and second tolerances. For each claim statement, it creates a call to a wrapper subroutine with the above parameters as arguments. The script consists of calls to this wrapper subroutine as well as other subroutines that perform sequence comparisons according to the arguments specified in the wrapper subroutine. When the script is run, the wrapper subroutine calls various subroutines according to the arguments and combines their results to produce the output for the claim statement.

To confirm that the script is correct, the script is tested at steps 444 and 446. First, the script is tested using an exemplary sequence from the subject patent document, i.e., from the patent document where the claim is being annotated. The registration module 15 obtains a sequence from the patent document itself or from the sequence library 40 and compares the sequences. The outcome for the sequence is known. In other words, the user knows what the result of the comparison should be.

Second, the script is tested using a randomly mutated sequence. The mutated sequence is based upon the exemplary sequence from the subject patent document. A random number generator is used to mutate the sequence. It generates two numbers. The first number corresponds to the position in the sequence. The second number is used to randomly select an amino acid at this position. The expected result is known. For example, the user knows what the result of the comparison should be when a sequence is mutated.

At step 454, the results of the two tests are analyzed. If the script is deemed “ok” (“Y” at step 454), then the claim record is populated by the registration module 15 with the input arguments and the generated script at step 456. The registration module 15 stores the claim record including the claim identifier, claim and patent document number, the matching criterion, any regular expressions, a first and second tolerance (if any), any special instructions, sequence identifiers, translated claim statements using the matching criterion and the generated script in the patent document library 35. Each set of information is separately stored in one of the field locations in the patent document library 35.

If the script is not “ok” (“N” at step 454), the script is corrected in step 458. The user double checks all of the input arguments, the computer generated arguments (arguments that the registration module 15 generated) and the script. Step 458 is repeated until the script is correct.

If at step 412, the claim is determined to be complex, the claim is divided into sub-statements, at step 500. The sub-statements are a set of simple statements that can be combined or aggregated using combinational logic. The user determines how to divide the claim. For example, a claim covering Seq ID 3 for LCDR 1 and Seq ID 2 for LCDR 2, can be divided into two sub-statements: one sub-statement being “Seq ID 3 for LCDR 1” and a second being “Seq ID 2 for LCDR 2”. Further, a claim covering Seq ID 3 or Seq ID 4 for LCDR 1 can also be divided into two sub-statements: one sub-statement being “Seq ID 3 for LCDR 1” and a second being “Seq ID 4 for LCDR 1”.

At step 502, one of the sub-statements (blocks) is selected for annotation. Steps 414-458 are repeated for each of the sub-statements. Step 414-458 have been described above and will not be described again in detail. Each sub-statement is individually tested and corrected. A sub-statement can also be simple or complex. If complex, the sub-statements are divided into smaller sub-statements or units. Each sub-statement can be assigned a different claim record, which is identified by patent document, claim and sub-statement. Each sub-statement will be displayed and the comparison result will also be separately displayed and ranked.

After each individual sub-statement is annotated, a logical relationship between each of the blocks is defined at step 504, such as “or”, “and”, “and(or)” and “or(and)”. Additionally, any special instructions for the combination can be set at step 506. For example, the special instructions for the combination can be “combined_identity”, “OR_regions_thresh” and “OR_groups_threshold” as described above and set forth in table 200 depicted in FIG. 2, row 7, third Column. The special instructions described in table 200 are only examples and other special instructions can be used with the clearance system 1.

After all the special instructions are set and the combined script is generated, the combined script with the special instructions is tested (steps 444-458). The testing is described above and will not be described again in detail.

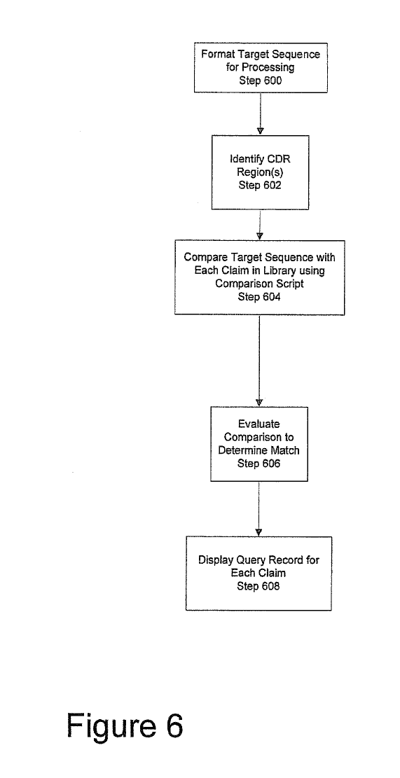

FIG. 6 illustrates a flow chart for a method for comparing a target sequence with the claims from the patent document library 35. At step 600, the target sequence is formatted for comparison. For example, the format can be, but is not limited to, a FASTA format. The CDR's are identified and annotated at step 602. A CDR is defined in the target sequence such that the amino acid sequence length is as large as possible for alignment purposes. The identification of a CDR is well known and need not be described in detail herein.

Once the preparation of the target sequence is complete, the relevant patent document library 35, e.g., patent document library 1, is retrieved. At step 604, the target sequence is compared with each of the claims from the patent document library 35 using the information in the claim record for each claim being analyzed. The comparison module 20 executes the computer generated script from the claim record for comparison. The relevant claimed sequences are retrieved from one of the sequence library(ies) 40_{N} for comparison. The target sequence is aligned with the claimed sequence.

Unless a special instruction was input or generated for a claim, the default comparison mode “comprises”. Thus, if the target sequence is longer than the claimed sequence, the corresponding gaps at the beginning or the end of the aligned sequences are not considered as mismatches. The comparison, at step 604, outputs a raw score or comparison result (“raw score”). The raw score for the NW algorithm is a number of mismatches between the target sequence and the claim statement (claimed sequence). The raw score for a SW algorithm is a percent identity between the target sequence and the claim statement (claimed sequence). The raw score for a regular expression is whether the pattern of the claimed sequence is matched or not, e.g. 0 for non-match and 1 for match. For a complex claim, the raw score is the list of all raw scores of the simple claims within it along with the overall summary.

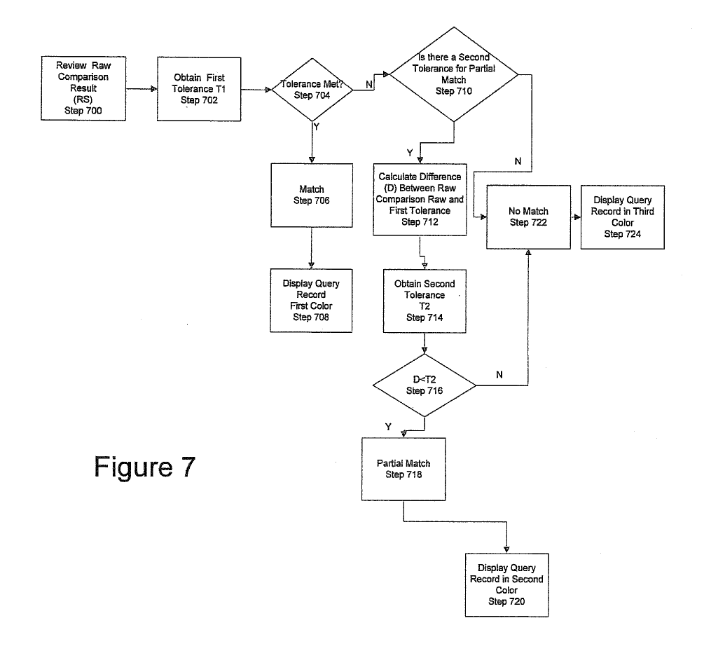

At step 606, the raw score is analyzed to determine whether the target sequence matches the claimed sequence. The analysis of the raw score will be described in detail later with respect to FIG. 7.

At step 608, the query record is displayed. The query record includes a claim number for the claimed sequence, the TransClaimStatement, raw comparison result and the decision about the match. Optionally, the query record can include a side-by-side display of the claimed sequence and the target sequence as evidence of the decision (or a relevant portion thereof). The query record for a complex claim can include the raw comparison result or raw score for each of the individual sub-statements, the decision for each of the sub-statements, and claimed sequence and the target sequence as evidence of the decision (or a relevant portion thereof) for each of the sub-statements. Additionally, for a complex claim, the query record can include the sub-statement that is matched as part of the result, e.g., matching CDRs.

FIG. 7 illustrates a flow chart showing exemplary steps for analyzing the raw score. At step 700, the raw score is reviewed. At step 702, the first tolerance T is retrieved from the claim record according to the script for the claim. At step 704, the comparison module 20 determines if the first tolerance condition has been met. The tolerance for a NW algorithm is a specified number of non-matches. The tolerance for a SW algorithm is a specified percentage. The tolerance for the regular expression is zero. No deviation is allowed.

If the NW algorithm is used as the matching procedure and the raw score is 2 and the tolerance is 3, than the target sequence matches the claim. A match would be declared at step 706. On the other hand, if the raw score is 4 and the tolerance is 3, than the target sequence does not match the claim. The process would move to step 710.

If the SW algorithm is used as the matching procedure and the raw score is 85% and the tolerance is 80%, than the target sequence matches the claim. A match would be declared at step 706. On the other hand, if the raw score is 75% and the tolerance is 80%, then the target sequence does not match the claim. The process would move to step 710.

If the regular expression is used as the matching procedure and there was a pattern match, then a match would be declared at step 706. A pattern match indicates that the tolerance is met.

If the target sequence matches the claim, the query record for the claim is displayed in a first color at step 708. The first color can be red.

If at step 704, the tolerance is not met, then the comparison module 20 determines if the user opted to include a second tolerance for a partial match, i.e., if the script includes a second tolerance. If there is no second tolerance (at step 710) and the first tolerance is not satisfied at step 704, the comparison module 20 declares that the target sequence does not match the claim at step 722.

If at step 710, the script contains a second tolerance, then the comparison module 20 calculates a difference between the raw score and the first tolerance, at step 712. The second tolerance T2 is obtained in step 714. The calculated difference is compared with the second tolerance, at step 716. If the calculated difference is less than the second tolerance T2, then a partial match is declared at step 718. If the target sequence partially matches the claim, the query record for the claim is displayed in a second color at step 720. The second color can be yellow.

If the calculated difference is greater than the second tolerance T2, then the target sequence does not match the claim. The comparison module 20 declares that the target sequence does not match the claim at step 722. If the target sequence does not match the claim, the query record for the claim is displayed in a third color at step 724. The third color can be green.

If the claim is complex, steps 700-706, 710-718 and 722 are repeated for each of the individual sub-statements (blocks). The match, no match and partial match declarations are aggregated into a combined result according to the determined combinational logic and special instructions for logical relationship in the script. When a target sequence does not fulfill all of the matching criterions, a target sequence partially matches a complex claim if a match is declared for at least one of the individual sub-statements, i.e., Y at step 704, or if a partial match is declared for at least one of the individual sub-statements, i.e., Y at step 716.

The clearance system 1 can be used to facilitate a consideration of clearance of antibodies generated by a entity, such as, but not limited to, companies, institutions, research facilities and universities , which can be generated by technologies such as, but not limited to, hybridoma and display technologies (e.g. phage display). The clearance system 1 can be used to facilitate a consideration of clearance of antibodies generated from animals including, but not limited to, mouse, rabbit and human. The clearance system 1 can be used to facilitate a consideration of clearance of chimeric antibodies. Furthermore, the clearance system 1 can be used to facilitate a consideration of clearance of a sequence and variations of the sequence. For example, an entity can file a patent for its antibody sequence and claim several variations of the sequence in the patent. The clearance system 1 can be used to check which variations in the sequence can be cleared, thus guiding which sequence variations to include in the entity's patent and be used.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for creating a computer readable data structure which is stored on a computer readable storage device, the computer readable data structure configured as a library of patent documents to be queried for clearance, the method comprising:
instantiating a computer readable data structure having a plurality of data fields;
for each patent document claim having a claim statement with at least one claimed sequence,
associating a patent document claim with a claim identifier;
receiving a matching criterion for a comparison of a target sequence with the patent document claim;
translating the claim statement based upon the matching criterion;
receiving a selection of a matching procedure based upon the matching criterion and the at least one claimed sequence;
receiving a description of the at least one claimed sequence using a sequence identifier for each of the at least one claimed sequence;
generating, using a processor, machine readable comparison instructions based upon the sequence identifier for each of the at least one claimed sequence, the matching criterion and the matching procedure; and
populating, using the processor, the plurality of data fields within the computer readable data structure with the claim identifier, the matching criterion, the matching procedure, the translated claim statement, described sequence identifier for each of the at least one claimed sequence, and the machine readable comparison instructions.

2. The method for creating a computer readable data structure according to claim 1, further comprising:
receiving a selection of a first tolerance level based upon the matching criterion, the first tolerance level being used to determine a match, wherein the first tolerance level is populated into one of the plurality of data fields within the computer readable data structure.

3. The method for creating a computer readable data structure according to claim 2, further comprising:
receiving a selection of a second tolerance level based upon the matching criterion, the second tolerance level being used to determine a partial match, wherein the second tolerance level is populated into another of the plurality of data fields within the computer readable data structure.

4. The method for creating a computer readable data structure according to claim 1, further comprising:
receiving a determination if patent document claim has a claim statement that is a complex statement, wherein if the claim statement is a complex statement, the method further comprises:
dividing the claimed statement into a plurality of sub-statements, where each of the plurality of sub-statements includes at least one claimed sequence;
receiving a determination of a logic relationship between each of the claim sub-statements;
receiving a matching criterion for a comparison for each of the plurality of sub-statements;
translating each of the sub-statements based upon the matching criterion;
receiving a selection a matching procedure based upon the matching criterion and the at least one claimed sequence in each of the plurality of sub-statements;
receiving a description of the at least one sequence using a sequence identifier for each of the plurality of sub-statements with a sequence identifier for each of the at least one sequence;
generating aggregate machine readable comparison instructions code for processing for all of the plurality of sub-statement, the aggregate machine readable comparison instructions including, the sequence identifier for each of the at least one sequence, the matching criterion and the matching procedure for each of the plurality of sub-statements and determined logic relationship; and
populating the plurality of data fields within the computer readable data structure with the claim identifier, the matching criterion for each of plurality of sub-statements, translated sub-statement, the matching procedure for each of the plurality of sub-statements, the described sequence identifier for each of the plurality of sub-statements, determined logic relationship and aggregate machine readable comparison instructions.

5. The method for creating a computer readable data structure according to claim 1, further comprising:
receiving at least one special comparison instruction for the selected matching procedure.

6. The method for creating a computer readable data structure according to claim 5, wherein the special comparison instruction is selected from a group consisting of counting a gap at a first and a second end of a sequence alignment as a mismatch, counting a gap at a first and a second end of a sequence alignment as a mismatch only when the target sequence is longer than the at least one claimed sequence, and calculating a percentage homology when using a global alignment.

7. The method for creating a computer readable data structure according to claim 4, further comprising:
receiving at least one special comparison instruction for the selected matching procedure.

8. The method for creating a computer readable data structure according to claim 7, wherein the special comparison instruction is selected from a group consisting of counting a gap at a first and a second end of a sequence alignment as a mismatch, counting a gap at a first and a second end of a sequence alignment as a mismatch only when the target sequence is longer than the at least one claimed sequence, calculating a percentage homology when using a global alignment, counting an aggregate number of mismatches in sequence alignment for each of the plurality of sub-statements, and calculating a combined identity over a plurality of sub-statements based on total length and number of mismatches, and a threshold number of matches for each of the plurality of sub-statements.

9. The method for creating a computer readable data structure according to claim 5, further comprising:
populating a field of the plurality of fields with the special comparison instruction; and
adding the special comparison instruction to the machine readable comparison instructions.

10. The method for creating a computer readable data structure according to claim 7, further comprising:
populating a field of the plurality of fields with the special comparison instruction; and
adding the special comparison instruction to the aggregate machine readable comparison instructions.

11. A method of facilitating consideration of clearance of a target sequence comprising:
retrieving a predefined patent document library data structure having fields for claim identifiers, a matching criterion for a comparison, translated claim statements, matching procedures, sequence identifiers, logical relationships between claim statements and machine readable comparison instructions;
retrieving a sequence database indexed by sequence identifier;
comparing the target sequence with each of the claims in the retrieved patent document library data structure, using corresponding machine readable comparison instructions and a sequence which is obtained from the retrieved sequence database corresponding to a sequence identified in the claim; and
determining whether each of claims in the retrieved patent document library data structure matches the target sequence based upon a result of the comparison.

12. The method of facilitating consideration of clearance of a target sequence according to claim 11, wherein the matching criterion includes a corresponding first tolerance level, and the determining comprises:
obtaining a raw comparison result from the comparing; and
comparing the raw comparison result with the first tolerance level.

13. The method of facilitating consideration of clearance of a target sequence according to claim 12, wherein if the raw comparison result satisfies the first tolerance level, the target sequence matches a claim.

14. The method of facilitating consideration of clearance of a target sequence according to claim 12, wherein the matching criterion includes a corresponding second tolerance level and the determining comprises:
obtaining a difference between the raw comparison result and the first tolerance level; and
comparing the obtained difference with the second tolerance level.

15. The method of facilitating consideration of clearance of a target sequence according to claim 14, wherein if the obtained difference is less than the second tolerance level, the target sequence partially matches a claim.

16. The method of facilitating consideration of clearance of a target sequence according to claim 11, further comprising displaying the determination.

17. The method of facilitating consideration of clearance of a target sequence according to claim 16, wherein a match is displayed in a first color, a partial match is displayed in a second color and a non-match is displayed in a third color.

18. The method of facilitating consideration of clearance of a target sequence according to claim 12, further comprising displaying a claim identifier for a claim, a translated claim statement, the raw comparison result and the determination, the claim identifier and the translated claim statement being retrieved from the predefined patent document library data structure.

19. The method of facilitating consideration of clearance of a target sequence according to claim 12, wherein at least a portion of a claimed sequence and the target sequence is displayed and is associated with the display of the claim identifier, the translated claim statement, the raw comparison result and the determination.

20. The method of facilitating consideration of clearance of a target sequence according to claim 12, wherein the comparing counts a gap at a first and second end of a sequence alignment as a mismatch only when the target sequence is shorter than the at least one claimed sequence, in a default mode.

21. A method for creating a computer readable data structure which is stored on a computer readable storage device, the computer readable data structure configured as a library of patent documents to be queried for clearance, the method comprising:
instantiating a computer readable data structure having a plurality of data fields;
providing a user interface for inputting annotations to a patent document claim having a claim statement with at least one claimed sequence;
receiving the input annotations, the input annotations being a matching criterion for a comparison of a target sequence with the patent document claim, a matching procedure, and a sequence identifier for each of the at least one claimed sequence;
generating, using a processor, machine readable comparison instructions based upon the sequence identifier for each of the at least one claimed sequence, the matching criterion and the matching procedure; and
populating, using the processor, the plurality of data fields within the computer readable data structure with the claim identifier, the matching criterion, the matching procedure, described sequence identifier for each of the at least one claimed sequence, and the machine readable comparison instructions.

22. A computer readable storage device tangibly embodying a computer readable program for causing a computer to execute a method comprising:
instantiating a computer readable data structure having a plurality of data fields;
providing a user interface for inputting annotations to a patent document claim having a claim statement with at least one claimed sequence;
receiving the input annotations, the input annotations being a matching criterion for a comparison of a target sequence with the patent document claim, a matching procedure, and a sequence identifier for each of the at least one claimed sequence;
generating, using the computer, machine readable comparison instructions based upon the sequence identifier for each of the at least one claimed sequence, the matching criterion and the matching procedure; and
populating, using the computer, the plurality of data fields within the computer readable data structure with the claim identifier, the matching criterion, the matching procedure, described sequence identifier for each of the at least one claimed sequence, and the machine readable comparison instructions.

23. A computer readable storage device tangibly embodying a computer readable program for causing a computer to execute a method comprising:
retrieving a predefined patent document library data structure having fields for claim identifiers, a matching criterion for a comparison, translated claim statements, matching procedures, sequence identifiers, logical relationships between claim statements and machine readable comparison instructions;
retrieving a sequence database indexed by sequence identifier;
comparing the target sequence with each of the claims in the retrieved patent document library data structure, using a corresponding machine readable comparison instructions and a sequence which is obtained from the retrieved sequence database corresponding to a sequence identified in the claim; and
determining whether each of claims in the retrieved patent document library data structure matches the target sequence based upon a result of the comparison.

24. The method for creating a computer readable data structure according to claim 1, further comprising:
receiving a first regular expression representing a matching pattern including all allowed variations at each position, for each position within the at least one claimed sequence;
receiving a group of special regular expressions, each special regular expression representing a specific matching pattern including all allowed variations for a different position within the at least one claimed sequence, wherein the group of special regular expressions is only used if the target sequence satisfies the first regular expression based upon the matching pattern and wherein a number of special regular expressions in the group of special regular expressions that is not satisfied equals a number of mismatches between the target sequence and the at least one claimed sequence.
